(19) United States
(12) Patent Application Publication
(10) Pub. No.: US 2009/0040200 A1
(43) Pub. Date: Feb. 12, 2009

(54) Method for driving display and a display driver thereof

(75) Inventors: Shih-Tsung Kan, Chungli City (TW); Ho-Nien Yang, Wurih Township (TW)

Correspondence Address: Joe McKinney Muncy, PO Box 1364, Fairfax, VA, 22038-1364, US

(73) Assignee: Orise Technology Co., Ltd.

(21) Appl. No.: 11/984,408

(22) Filed: Nov. 16, 2007

(30) Foreign Application Priority Data
Aug. 8, 2007 (TW) 096129141

(51) Int. Cl. G06F 3/045

(52) U.S. Cl. 345/204

(57) ABSTRACT

The present invention relates to a method for driving a display adapted for solving afterimage in moving picture and a display driver thereof. The method includes the steps of: dividing a frame of the display into a plurality of areas; dividing a frame period into a first display period and a second display period; displaying a specific color at a specific area of the areas and displaying an image corresponding to a display data in the areas neighbored to the specific area in the first display period; and displaying the specific color at the areas neighbored to the specific area and displaying the image corresponding to the display data at the specific area in the first display period.

This application claims the benefit of the filing date of Taiwan Application Ser. No. “096129141”, filed on “Aug. 8, 2007”, the content of which is incorporated herein by reference.

### BACKGROUND OF THE INVENTION

1. Field of the Invention

The present invention relates to a driving method for a display, and more particularly, to a display driving method for solving after image and a display driver thereof.

2. Description of the Related Art

In recent years, due to the development of technology, the cathode ray tube (CRT) display is gradually replaced by flat panel display. Presently, the most popular flat panel display is liquid crystal display (LCD). Due to the advantageous features of LCD, for example, high definition, high space utilization efficiency, low power consumption, free radiation, and low electrical field interference, LCD has become main stream on the market. FIG. 1A shows a schematic configuration of a prior LCD device. Referring to FIG. 1A, a LCD device 100 includes a LCD panel 110, a source driver circuit 120, a gate driver circuit 130, a timing controller 140 and a gamma adjustment circuit 150.

The LCD panel 110 is used to display images. A plurality of data lines 121 and a plurality of scanning lines 131 (e.g. 640×480) are disposed in a grid like arrangement on the LCD panel 110. A TFT (thin film transistor) 111 and a capacitor 112 are provided in the vicinity of each point of intersection between the data lines 121 and scanning lines 131. The capacitor 112 includes a pixel electrode 112a, a common electrode 112b and a liquid crystal layer 112c. A gate electrode of TFT 111 is connected to the scanning line 131, a source electrode is connected to the data line 121, and a drain electrode is connected to the pixel electrode 112a of the capacitor 112. The gamma adjustment 150 applies at least a reference voltage to the source driver circuit 120. Besides, the timing controller 140 generates different control signals and control voltages to the source driver circuit 120 and the gate driver circuit 130.

If the liquid crystal material is continuously applied with a DC voltage with same polarity, the liquid crystal material will likely be damaged. To prevent the damage to the liquid crystal material, the polarity of the data signal applied to the liquid crystal material is periodically inverted (so-called AC driving), as well know in the art.

FIG. 1B shows a schematic configuration of a prior source driver circuit. The source driver circuit 120 consists of a plurality of source driver 160. Each source driver 160 includes two data buffers 161, 161′, a positive digital-to-analog converter 162, a negative digital-to-analog converter 163, a positive amplifier 164, a negative amplifier 165 and a switch module 166 made up of four switches SW1˜SW4. Based on the AC driving, the source driver 160 respectively receives two digital image signals D1, D2, and simultaneously receives a set of positive analog voltage signals Vref1 and a set of negative analog voltage signals Vref2 from the gamma adjustment 150. After two digital image signals D1, D2 are converted and amplified, a positive analog image signal and a negative analog image signal are alternately output from the output terminals S1, S2 of the driver 160 for every predetermined period of time by controlling four switches SW1˜SW4. Four switches SW1˜SW4 are controlled by a control signal CS_SW, which includes a first switch control signal, a second switch control signal, a third switch control signal and a fourth switch control signal for respectively controlling switches SW1˜SW4. Since the method of using the control signal CS_SW to control the switches SW1˜SW4 is well known, the description is omitted here.

If motion picture display is conducted on the prior LCD device, an afterimage problem will arise. The cause of this problem is that because the response speed of the liquid crystal material is low and the response time is relatively long. When an object is moving fast in a frame, the liquid crystal is unable to track the path of the object within a frame period, but produces a cumulative response using several frame periods. Several researches have been conducted to overcome the afterimage problem as follows: (1) Intrinsic property: Convert the property of the liquid crystal material into low viscosity. (2) Overdriving: The response of the liquid crystal material can be increased by overdriving each pixel. (3) Black insertion: Following the display of each image for one frame, the entire screen is switched to a black display by inserting the black data, before the image for the next frame is displayed.

FIG. 2A shows a timing diagram for sequentially supplying of the gate driving signals to the scanning lines of a conventional LCD device. In U.S. Pat. No. 6,473,077, IBM discloses a liquid crystal display device using black insertion concept. FIG. 2B shows a timing diagram of sequential gate driving signals output from a gate driver circuit 130 of the liquid crystal display device to the scanning lines. Based on the same black insertion concept, in U.S. Pat. No. 6,819,311, NEC reveals another liquid crystal display device for displaying motion pictures. FIG. 2C shows a timing diagram of sequential gate driving signals output from a gate driver circuit 130 of another liquid crystal display device for displaying motion pictures to the scanning lines.

Referring to FIG. 2A, there is a gate driving signal with a time period TG supplied to each scanning line within a frame period while the gate driving signal supplied to each scanning line comprises a first trigger pulse P1 and a second trigger pulse P2 within a frame period as shown in FIGS. 2B and 2C.

As shown in FIG. 2B, one frame period is divided into two halves. An image for one frame is displayed during the first half of frame period, and the black image is displayed during the second half of frame period. Referring to FIG. 2C, the gate driver circuit 130 interlacedly activates a pixel line for image data and then another pixel line for black data which is separated by a predetermined number of scanning lines from the pixel line for image data. In this manner, the interlaced activated pixel lines are sequentially displayed on the LCD device. Comparing FIG. 2A˜2C, the scanning frequency of the gate driver circuit 130 in FIG. 2B or FIG. 2C is doubled, since the width TG of the gate driving signal on each scanning line in FIG. 2A is reduced into the width TG/2 of the trigger pulse P1 or P2 as shown in FIG. 2B or FIG. 2C. That is, the operation time of the gate driver circuit 130 is reduced to one-half, and the data driving speed of the source driver circuit 120 is also doubled in order to coordinate with the scanning frequency of the gate driver circuit 130.

Although the afterimage problem can be solved with NEC's or IBM's architecture, but the abovementioned methods use inserting a black image between two normal images. So that user is easy to observe the flicker phenomenon.

### SUMMARY OF THE INVENTION

In view of the above-mentioned problems, the present invention is direct to a method for driving a display and a display driver using the method, which is for solving the afterimage and the flicker problems.

To achieve the above-mentioned object and others, a method for driving a display is provide in the present invention, which is adapted for solving the afterimage. The method includes: dividing a frame into a plurality of display areas; dividing a frame period into a first display period and a second display period; in the first display period, inserting a specific color into a specific area of the display areas and displaying an image corresponding to a display data in the display areas neighbored with the specific area; and in the second display period, displaying the image corresponding to the display data in the specific area and inserting the specific color into the display areas neighbored with the specific area

According to the method for driving the display in the embodiment of the present invention, the display areas is M×N, and in the first display period, the area of the coordinate (i, j) displays the specific color and the areas of coordinate (i+1, j), the coordinate (i−1, j), the coordinate (i, j+1), the coordinate (i, j−1) display the image according to the display data, in the second display period, the area of the coordinate (i, j) displays the image corresponding to the display data and the areas of coordinate (i+1, j), the coordinate (i−1, j), the coordinate (i, j+1), the coordinate (i, j−1) display the specific color. In the further embodiment of the present invention, the abovementioned specific color is a black color or any gray scales color, and the abovementioned display areas respectively represent a pixel.

A display driver is provided in the present invention, which is adapted for solving the afterimage of a display device, wherein a frame of the display device is divided into a first area and a second area. The display driver includes a frame buffer and a timing controller. In addition, a frame period is divided into a first display period and a second display period. The frame buffer is used for storing a display data, wherein the display data includes a first area data and a second area data. The first area data corresponds to the first area of the display device. The second area data corresponds to the second area of the display device. In the first display period, the timing controller uses the first area data to drive the first area of the display device and controls the second area of the display device to display a specific color. In the second display period, the timing control circuit uses the second area data to drive the second area of the display device and controls the first area of the display device to display the specific color.

According to the display driver in the preferring embodiment of the present invention, the frame of the display device is divided into M×N areas. In the first display period, the timing control circuit drives the area of the coordinate (i, j) to display the specific color, and drives the areas of the coordinates (i+1, j), (i−1, j), (i, j+1) and (i, j−1) to display images according to the display data. In the second display period, the timing control circuit drives the area of the coordinate (i, j) to display an image according to the display data, and drives the areas of the coordinates (i+1, j), (i−1, j), (i, j+1) and (i, j−1) to display the specific color. In the further embodiment of the present invention, the abovementioned specific color is a black color or any gray scale colors, and the abovementioned display areas respectively represent a pixel.

The essence of the present invention utilizes to divide a frame into a plurality display areas and then to insert a specific color to a specific area, instead to insert a black color to whole frame. Since it has complementary to vision no matter in time domain or spatial domain in the present invention, the flicker can be reduced.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1A shows a schematic configuration of a prior LCD device.

FIG. 1B shows a schematic configuration of a prior source driver circuit.

FIG. 2A shows a timing diagram for sequentially supplying of the gate driving signals to the scanning lines of a conventional LCD device.

FIG. 2B shows a timing diagram for sequentially supplying of the gate driving signals to the scanning lines of another conventional LCD device.

FIG. 2C shows a timing diagram for sequentially supplying of the gate driving signals to the scanning lines of also another conventional LCD device.

FIG. 3 shows a flow chart depicting a method for driving a display according to an embodiment of the present invention.

FIG. 4 shows a diagram depicting the correlation between time and displayed frame according to an embodiment of the present invention.

FIG. 5 shows a circuit diagram depicting a display device according to an embodiment of the present invention.

FIG. 6 shows a diagram depicting the correlation between time and displayed frame according to an embodiment of the present invention.

FIG. 7 shows a diagram depicting the correlation between time and displayed frame according to an embodiment of the present invention.

FIG. 8 shows a detailed circuit diagram depicting a display device according to an embodiment of the present invention.

FIG. 9 shows a data-timing diagram according to an embodiment of the present invention.

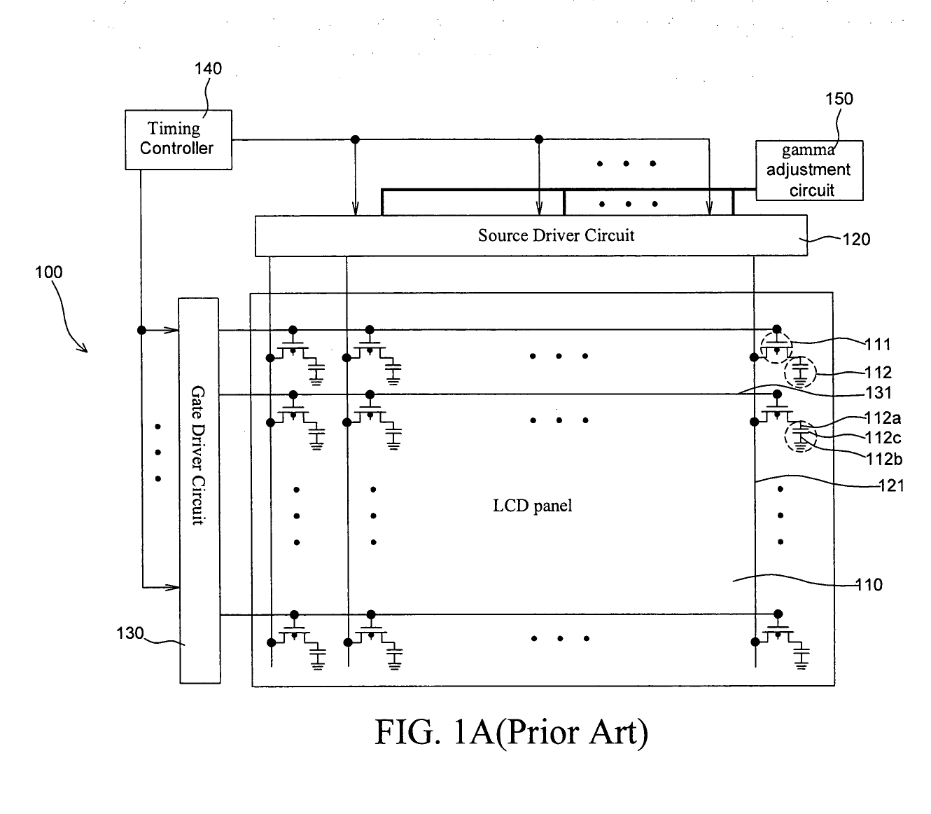

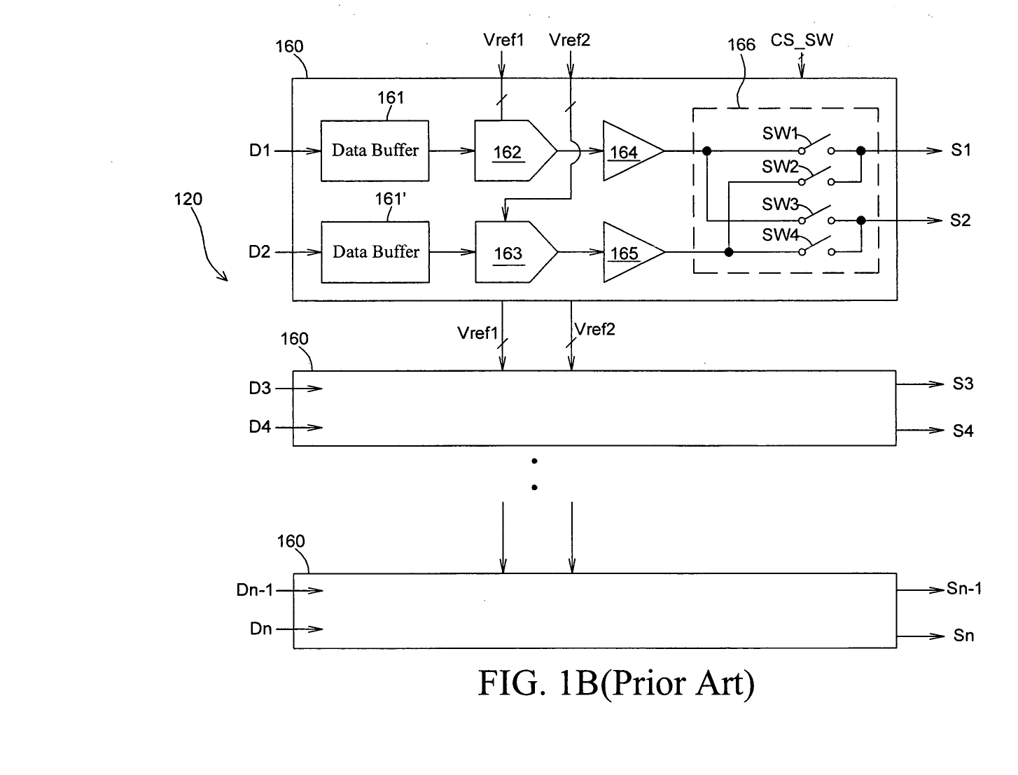

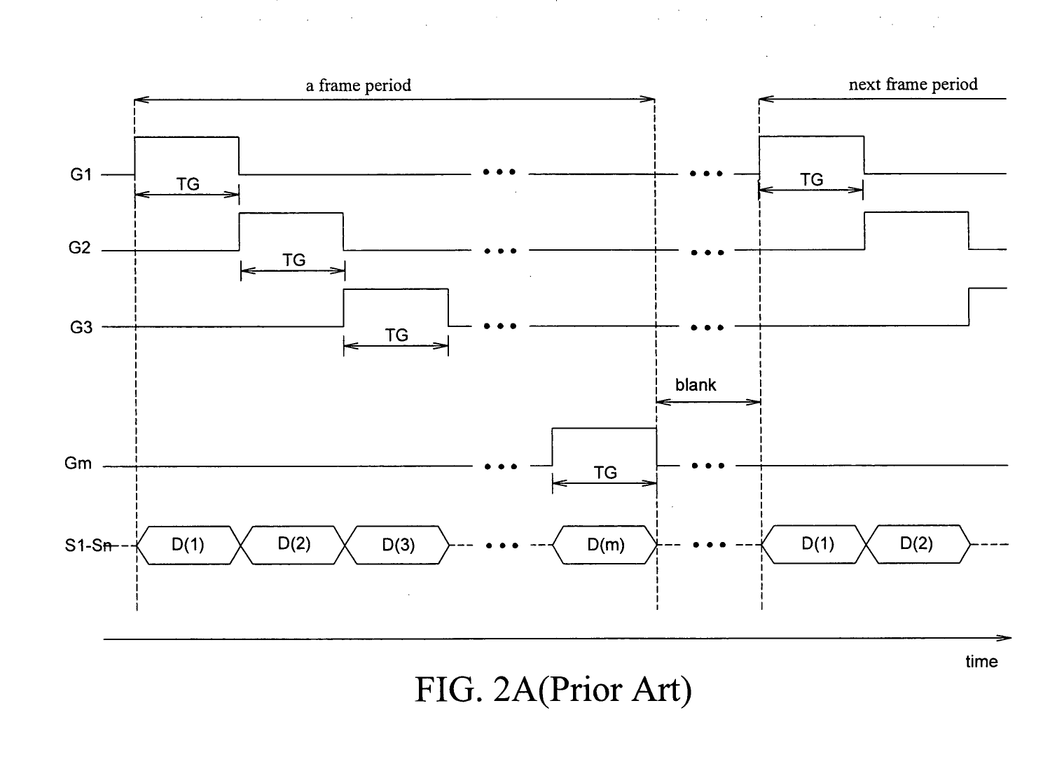

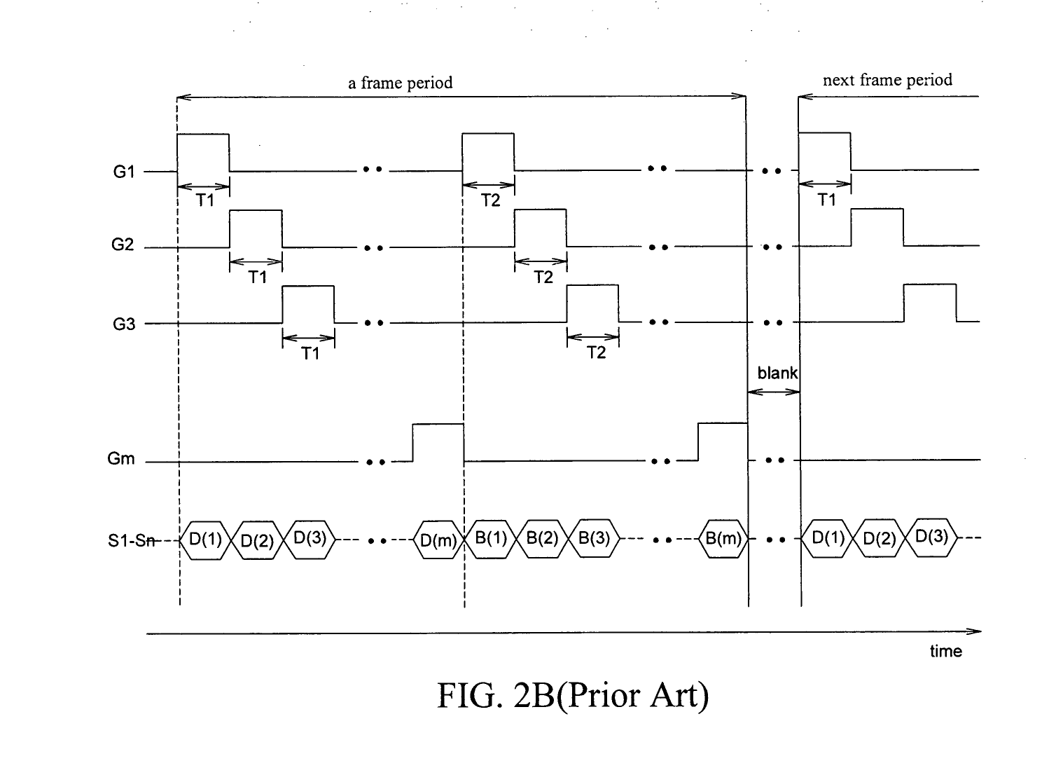

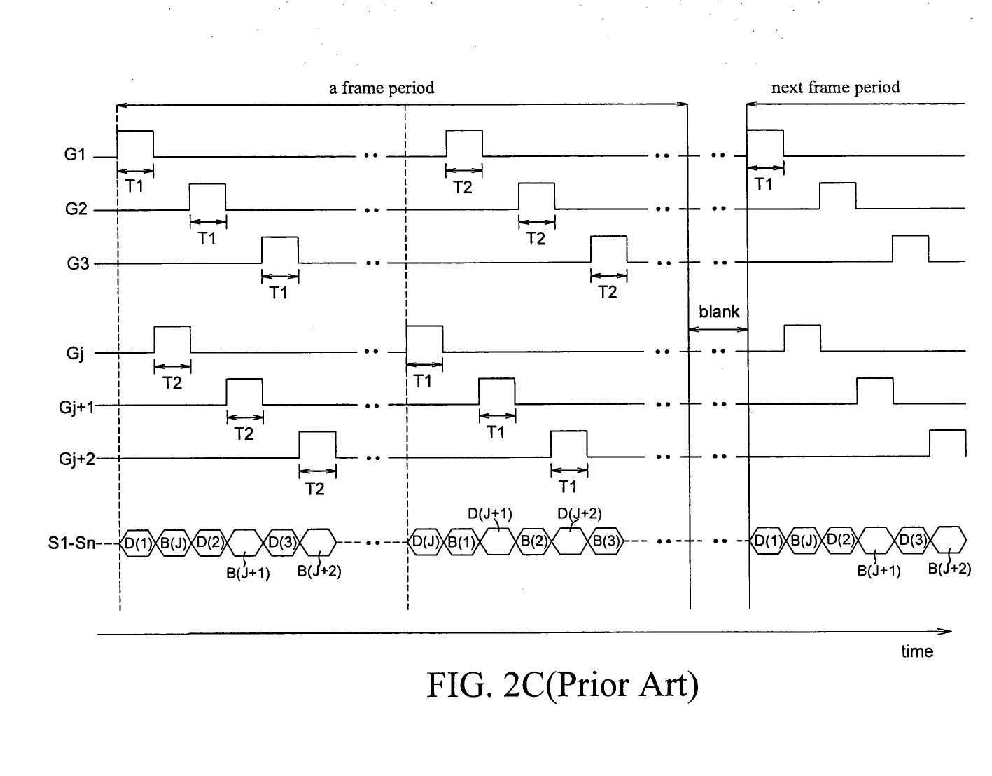

### EMBODIMENT OF THE INVENTION

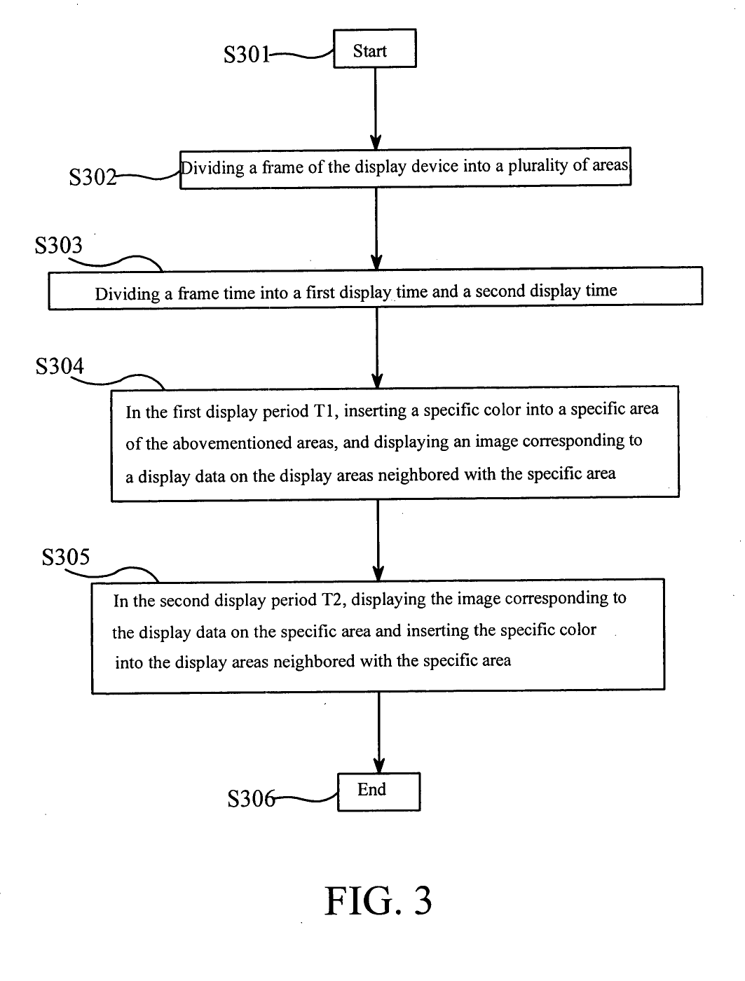

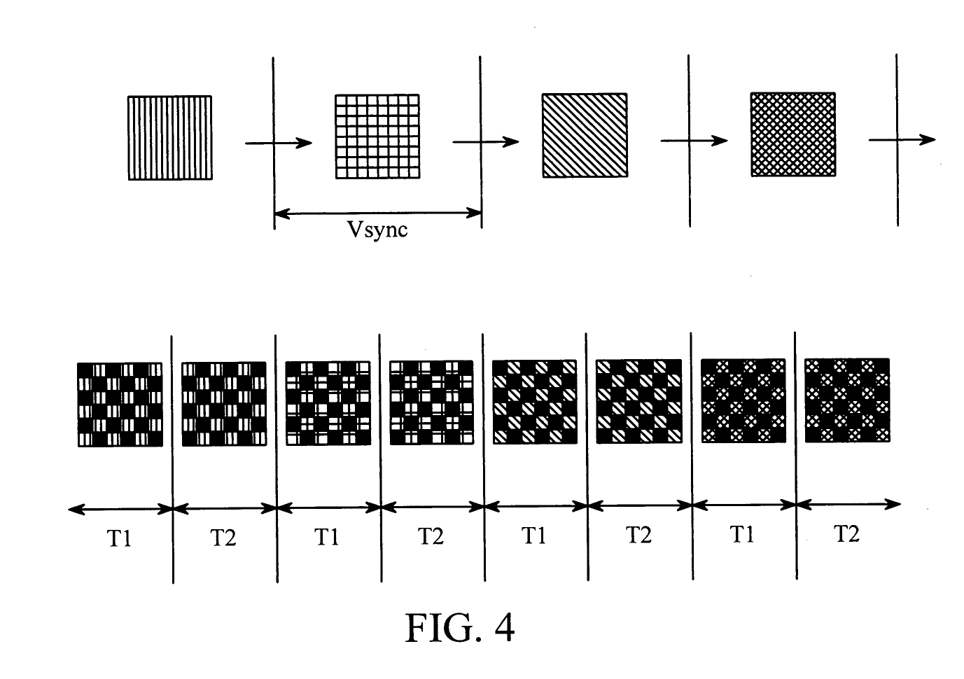

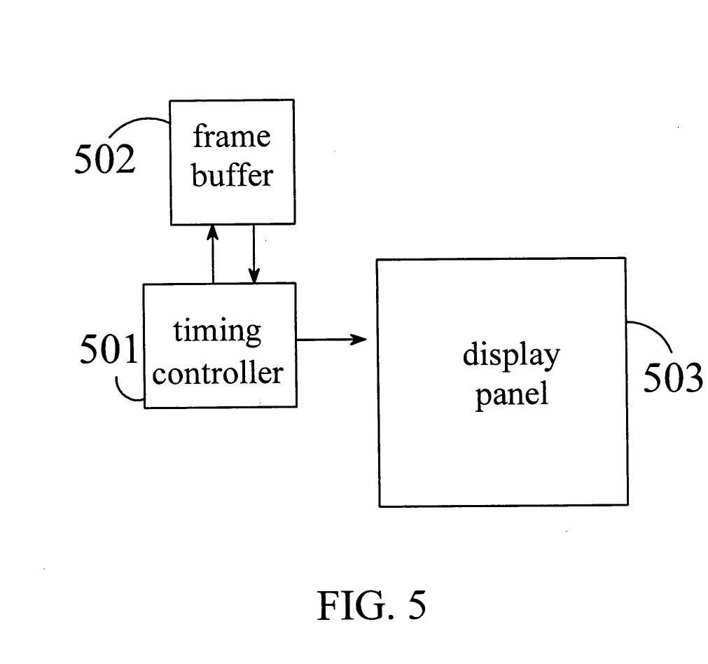

FIG. 3 shows a flow chart depicting a method for driving a display according to an embodiment of the present invention. FIG. 4 shows a diagram of correlation between time and displayed frame according to an embodiment of the present invention. FIG. 5 shows a circuit diagram of the display device according to an embodiment of the present invention. Referring to FIG. 5, the display device includes a timing controller 501 of the embodiment of the present invention, a frame buffer 502 and a display panel. Generally, a received display data will be stored into the frame buffer 502 in advance. Next, referring to FIG. 3, FIG. 4 and FIG. 5.

Step S301: Start.

Step S302: Dividing a frame of the display device into a plurality of areas. In this embodiment, the frame is divided to become a form of chessboard.

Step S303: Dividing a frame period into a first display period and a second display period. Generally, the frame period can be a vertical synchronous time Vsync. In this embodiment, the vertical synchronous time Vsync is divided into two display periods T1 and T2. The timing controller 501 would drive the display panel 503 according to the two display periods T1 and T2.

Step S304: In the first display period T1, inserting a specific color into a specific area of the abovementioned areas, and displaying an image corresponding to a display data on the display areas neighbored with the specific area. As FIG. 4 shows, in the first display period T1, the area 401 is inserted a black color and the areas 402, 403, 404 and 405 surrounding the area 401 respectively display an image according to the display data. Before the display period T1, the timing controller 501 would take half the display data out from the frame buffer 502. Afterward, the timing controller 501 would arrange the display data sequence according to the taken display data, and fill the missing half with the black data. In the display period T1, the display data arranged by timing controller 501 will be transmitted to the display panel 503. Therefore, the display panel 503 will show an image as a chessboard in the first display period T1.

Step S305: In the second display period T2, displaying the image corresponding to the display data on the specific area and inserting the specific color into the display areas neighbored with the specific area. As FIG. 4 shows, in the second display period T2, the area 401 normally display the image according to the display data and the areas 402, 403, 404 and 405 surrounding the area 401 is displayed the black color. Before the display period T2, the timing controller 501 would take out another half display data from the frame buffer 502 in advance. Afterward, the timing controller 501 would arrange the display data sequence, and fill the missing half with the black data. And then, in the display period T2, timing controller 501 transmit the arranged display data to the display panel 503. Therefore, in the second display period T2, the display panel 503 will show an image as a chessboard which is reversed with the image in the display period T1.

Step S306: End.

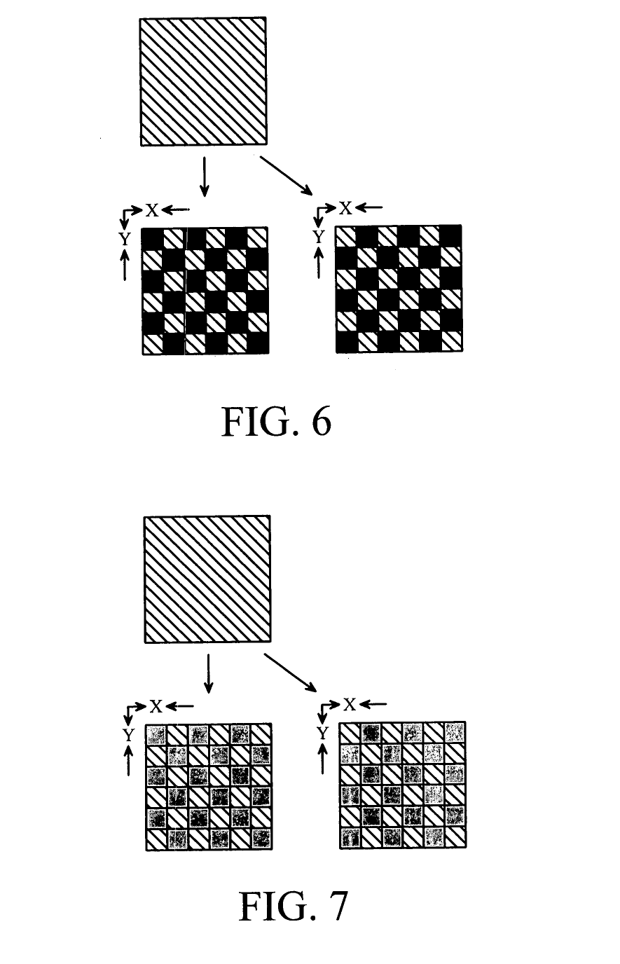

It should be noted that the embodiment utilizes dividing a frame into a plurality display areas and then inserting a specific color to a specific area, instead inserting a black color to frame in the prior art. Thus, the embodiment can be efficaciously reduced the flicker phenomenon. Although, the abovementioned embodiment utilizes dividing a frame into a plurality display areas to display, person having ordinary skill in the art should understand that the size of the area can be changed according to the different application. Referring to FIG. 6, FIG. 6 shows a diagram depicting the correlation between time and displayed frame according to an embodiment of the present invention. The grid size is not limit to square. It can be set as X pixel×Y pixel size area, wherein the X and the Y respectively are nature number. Generally, if the grid size is reduced, the flicker phenomenon will be reduced, comparatively, the display quality will be increased. In addition, although the abovementioned embodiment is used the black color to be an example, but person having ordinary skill in the art, who refer to the abovementioned embodiment, should understand that the black color is a preferring example, and any gray scale color can have the same effect as the black color, such as FIG. 7. FIG. 7 shows a diagram depicting the correlation between time and displayed frame according to an embodiment of the present invention. The inserting color is not limit to the black color. It can be any gray scale color.

In order that people having ordinary skill in the art may implement the embodiment, an explicit embodiment is described in the following.

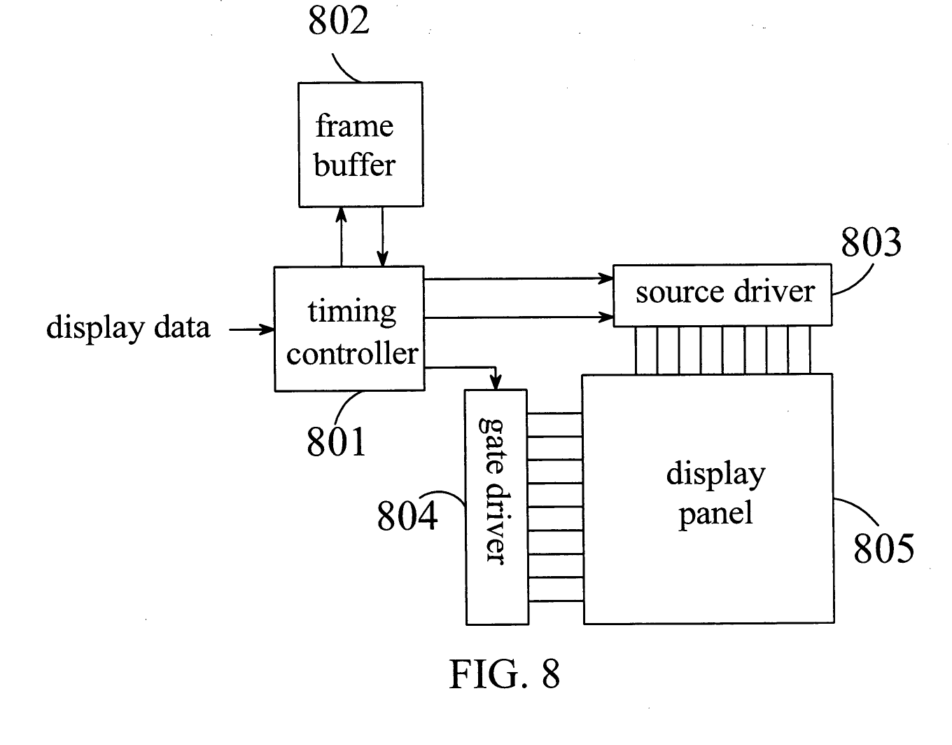

FIG. 8 shows a detailed circuit diagram depicting a display device according to an embodiment of the present invention. Referring to FIG. 8, the display device includes a timing controller 801, a frame buffer 802, a source driver 803, a gate driver 804 and a display panel 805. When a display data of a frame is received, the timing controller 801 will store the display data to the frame buffer 802. When a display data of next frame is received, the timing controller 801 will read the display data of the former frame out from the frame buffer 802.

The operation of the timing controller 801 is: reading the odd pixels (1, 3, 5, 7 . . . ) data of the first line of the frame, next, inserting black data as the even pixels data of the first line and outputting it to the source driver 803; and then, reading the even pixels (2, 4, 6, 8, . . . ) data of the second line of the frame, next, inserting the black data as the odd pixels data of the second line and outputting it to the source driver 803 . . . and the rest may be deduced by analogy. When the abovementioned operation is finished, the even pixels (2, 4, 6, 8, . . . ) data of the first line of the frame start to be read . . . and the rest may be deduced by analogy. In addition, in the process of the operation, since the display data will continuously input, thus the timing controller 801 will continuously write the display data into the frame buffer 802.

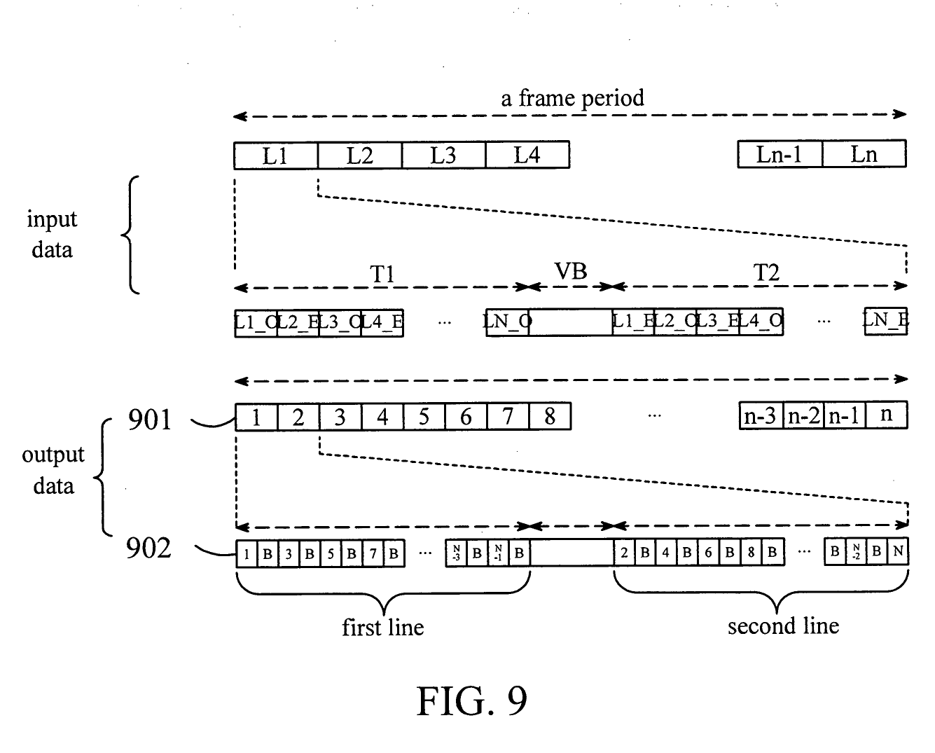

FIG. 9 shows a data-timing diagram according to an embodiment of the present invention. Referring to FIG. 9, the symbol “B” in FIG. 9 represents the outputted black data. When a complete frame is inputted, the timing controller 801 will control the frame rate to be double, as S303, and outputting two frames in a frame period according to the abovementioned operation. The symbol “VB” represents the vertical blank period. As the figure, it should be noted that the outputted data will be outputted as 901 and 902 in the FIG. 9. Therefore, the display panel 805 will display two images respectively as two reversed chessboards in a frame period.

To sum up, the essence of the present invention utilizes to divide a frame into a plurality display areas and then to insert a specific color to a specific area, instead to insert a black color to whole frame. Since the conventional black insertion is inserting a whole black frame between two frames, so that the flicker phenomenon in vision will be easily felt. The essence of the present invention is dividing a frame into a plurality display areas and then inserting a specific color to a specific area, so it has complementary to vision no matter in time domain or spatial domain. Therefore, the flicker phenomenon can be reduced and the afterimage can be solved in the same time.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A method for driving a display, the method is adapted for solving an afterimage, comprising:
dividing a frame of the display into a plurality of areas;
dividing a frame period into a first display period and a second display period;
in the first display period, inserting a specific color into a specific area of the areas and displaying an image corresponding to a display data on the display areas neighbored with the specific area; and
in the second display period, displaying an image corresponding to the display data on the specific area and inserting the specific color into the display areas neighbored with the specific area.

2. The method according to claim 1, wherein the frame of the display is divided into M×N areas, and in the first display period, the method comprises:
inserting the specific color into the area of the coordinate (i, j) and display the image corresponding to the display data in the areas of the coordinates (i+1, j), (i−1, j), (i, j+1) and (i, j−1).

3. The method according to claim 1, wherein the frame of the display is divided into M×N areas, and in the second display period, the method comprises:
inserting the specific color into the areas of the coordinates (i+1, j), (i−1, j), (i, j+1) and (i, j−1) and display the image corresponding to the display data in the area of the coordinate (i, j).

4. The method according to claim 1, wherein the areas respectively represent a pixel.

5. The method according to claim 1, wherein the specific color is a black color.

6. The method according to claim 1, wherein the specific color can be any gray level color.

7. A display driver adapted for solving an afterimage of a display device, wherein a frame of the display is divided into a first area and a second area, the display driver comprising:
a frame buffer, for storing a display data which comprises a first area data and a second area data, wherein the first area data corresponds to the first area and the second area data corresponds to the second area; and
a timing controller, dividing a frame period into a first display period and a second display period, wherein the timing controller uses the first area data to drive the first area and controls the second area to display a specific color in the first display period, and the timing controller uses the second display data to drive the second area and controls the first area to display the specific color.

8. The display driver according to claim 7, wherein the frame of the display is divided into M×N areas, and in the first display period, the timing controller drives the area of the coordinate (i, j) to display the specific color, and drives the areas of the coordinates (i+1, j), (i−1, j), (i, j+1) and (i, j−1) to respectively display an image corresponding to the display data.

9. The display driver according to claim 7, wherein the frame of the display is divided into M×N areas, and in the second display period, the timing controller drives the areas of the coordinates (i+1, j), (i−1, j), (i, j+1) and (i, j−1) to display the specific color, and drives the area of the coordinate (i, j) to display an image corresponding to the display data.

10. The display driver according to claim 7, wherein the areas respectively represent a pixel.

11. The display driver according to claim 7, wherein the specific color is a black color.

12. The display driver according to claim 7, wherein the specific color can be any gray level color.
